(19) United States
(12) Patent Application Publication
(10) Pub. No.: US 2004/0027036 A1
(43) Pub. Date: Feb. 12, 2004

(54) System for safely inspecting matter possibly containing chemical or biological agents

(76) Inventor: Jim Hall, Georgetown, MA (US)

Correspondence Address: DEVINE, MILLIMET & BRANCH, P.A., 111 AMHERST STREET, BOX 719, MANCHESTER, NH, 03105, US

(21) Appl. No.: 10/286,699

(22) Filed: Nov. 1, 2002

Related U.S. Application Data
(60) Provisional application No. 60/335,188, filed on Nov. 2, 2001.

(51) Int. Cl. A61G 11/00

(52) U.S. Cl. 312/1

(57) ABSTRACT

In a simple, preferred embodiment, the present invention is a plastic, gas-impermeable, sealable container with gloves affixed therein. Any package or material can be sealed within the container and safely opened and inspected using the gloves without fear any chemical/biological agent will permeate the gloves or the container. Principally, the present invention was viewed as a cost-effective tool for individuals to handle and/or open mail and determine if any unexpected, harmful substances are inside. For this purpose, placing a letter opener, a knife, scissors, or any other tool within the container would also be useful. The present invention can also be utilized in other ways.

The present application claims priority based on Provisional Application Serial No. 60/335188, filed Nov. 2, 2002.

### FIELD OF THE INVENTION

The present invention is in the field of hazardous material containment and inspection apparatus. Specifically, the present invention is directed toward inexpensive apparatus for handling matter that may be infected by or contain hazardous material.

### BACKGROUND OF THE INVENTION

Following the events of Sep. 11, 2001, citizens of the United States were subjected to an Anthrax attack. Several citizens became infected as a result of Anthrax spores transported through mail delivered by the United States Postal Service. In response to the attack, many government agencies began radiating mail, while other fearful citizen and entities had their mail routinely tested for Anthrax. While the attack has subsided, the possibility of another, similar attack with a chemical or biological agent remains.

While government agencies and prominent citizens were able to take measures to protect themselves from the Anthrax threat, the average United States citizen was less defensible due to economic reasons. Some average citizens were victimized by the seemingly arbitrary attack. The measures taken by the government agencies in radiating mail were expensive and unavailable to the average United States citizen. Similarly, Anthrax detection devices were not available to the average United States citizen for economic reasons. Ideally, the average citizen would have some means at their disposal to protect themselves from a similarly anonymous and arbitrary future chemical or biological attack.

Many United States Postal Service (“USPS”) were also exposed to risks during the Anthrax attack. At least a few USPS workers were infected by Anthrax as a result of handling infected mail. Even when the USPS was subjecting mail to radiation, some USPS workers were handling the mail from collection boxes, mail boxes and post office boxes to deliver the mail to a location for radiation. Ideally, the USPS workers would have a cost effective means of handling the mail without exposing themselves to chemical or biological attack.

Beyond the mail, future attacks may involve the transportation and delivery of biological or chemical agents through other vehicles, even individuals. Therefore, a cost-effective, mass-producible device is needed the average individual can afford and obtain to safely handle and inspect materials that may be infected by chemical or biological agents.

### SUMMARY OF INVENTION

The present invention is a system for safely receiving and inspecting materials containing any chemical or biological agents. It is a simple and inexpensive system, which can be mass-produced, that allows the recipient of any package or material, or any governmental employee who is required to handle any package or material, to safely open and inspect any package or material without significant governmental manpower or budgetary requirements.

In a simple, preferred embodiment, the present invention is a gas-impermeable, sealable container, preferably made of a translucent, flexible material, with gloves affixed therein. Any package or material can be placed within the container and safely opened and inspected without fear any chemical/biological agent will permeate the container. Originally, the present invention was viewed as a cost-effective tool for mail handlers (mail recipients, postal workers, package handlers, etc.) to handle and/or open mail and determine if any unexpected, harmful substances are inside. For this purpose, placing a letter opener, a knife, scissors, or any other tool within the container would also be useful. The present invention can also be utilized in other ways.

The present invention has many cost-effective uses for hazardous environment scenarios. The container can be used at crime scenes and for forensic work to analyze evidence without contaminating its evidentiary value. If the container is made large enough to contain a person, the invention can be used by morticians or morgues to avoid exposure to germs carried by a corpse or to perform an autopsy. Also, if the container is equipped with an air filter, the container could be used to contain a quarantinable, patient for examination without exposing the doctors or ambulance medics to risk. The invention could even be used for food preparation, to avoid possible food contamination. Other uses are also available, with the primary purpose of the invention being a means of handling an object without either exposing the object to outside contaminates or exposing the handler to contaminates carried by the object.

### BRIEF DESCRIPTION OF THE DRAWINGS

These and other features and advantages of the present invention will be better understood by reading the following detailed description, taken together with the drawings.

FIG. 1 shows one embodiment of the inventive apparatus.

FIG. 2 shows one embodiment of the inventive apparatus applied within a residential mailbox.

FIG. 3 shows another embodiment of the inventive apparatus.

FIG. 4 shows a pair of mateable rings for use in one embodiment of the inventive apparatus.

FIG. 5 shows another embodiment of the inventive apparatus.

FIG. 6 is a flow diagram of one embodiment of the inventive apparatus.

FIG. 7 is another flow diagram of one embodiment of the inventive apparatus.

### DETAILED DESCRIPTION

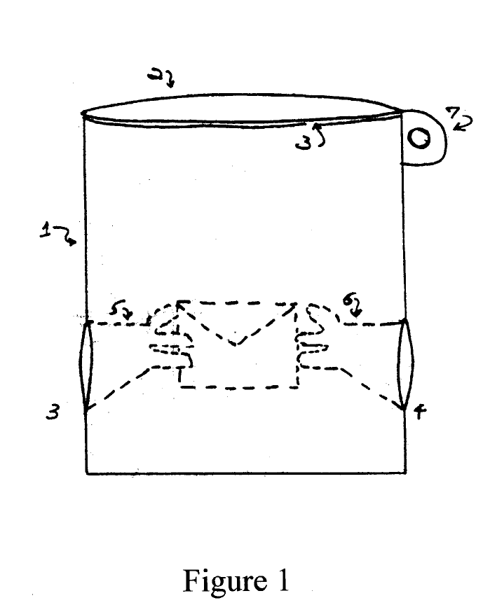

Referring to FIG. 1, the system comprises a bag 1 constructed out of a substantially gas impermeable, transparent material, such as a 3 mil. thick plastic, or an opaque material with a substantially transparent section creating a window therein. The bag 1 may be constructed in different sizes to allow the manipulation within the bag of various sized letters or packages. Other considerations in determining the size of the bag 1 are whether or not it is to fit inside a mailbox or post office box and whether or not it is to contain implements, such as scissors or a knife, for opening any letter or package placed therein.

The bag has an opening 2 that can be closed to form a substantially airtight seal by closure means 3, which can be tape or any one of a number of resealable closure means known to persons skilled in the art.

The bag 1 has multiple openings 3 and 4 from which gloves or mittens 5 and 6 are deployed in the interior of the bag 1. The gloves or mittens 5 and 6 are also made of a substantially gas impermeable material. The bag 1 may also have a hanging means 7, such as an opening that may be slipped over a hook or other projection or a flap that may be tacked to a wall, to allow for the bag to be hung from a hook or projection or a wall.

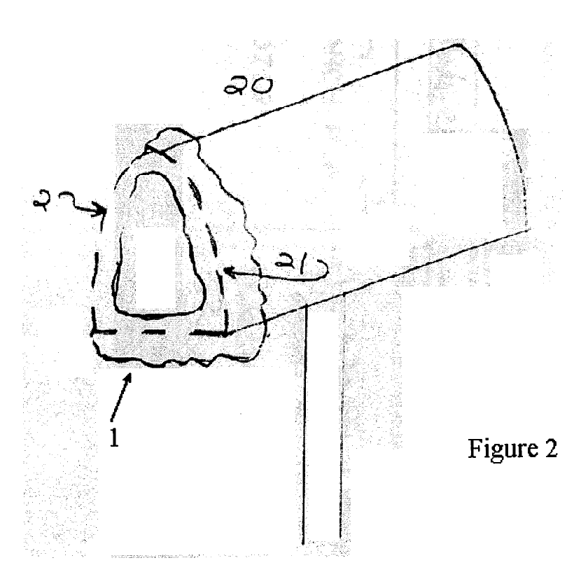

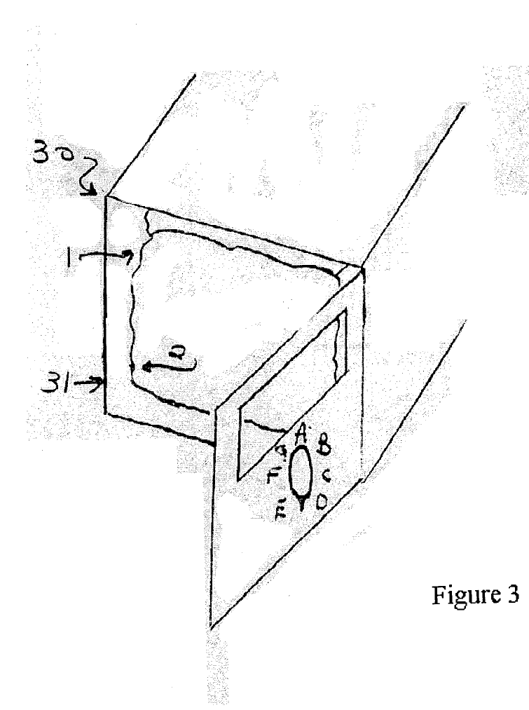

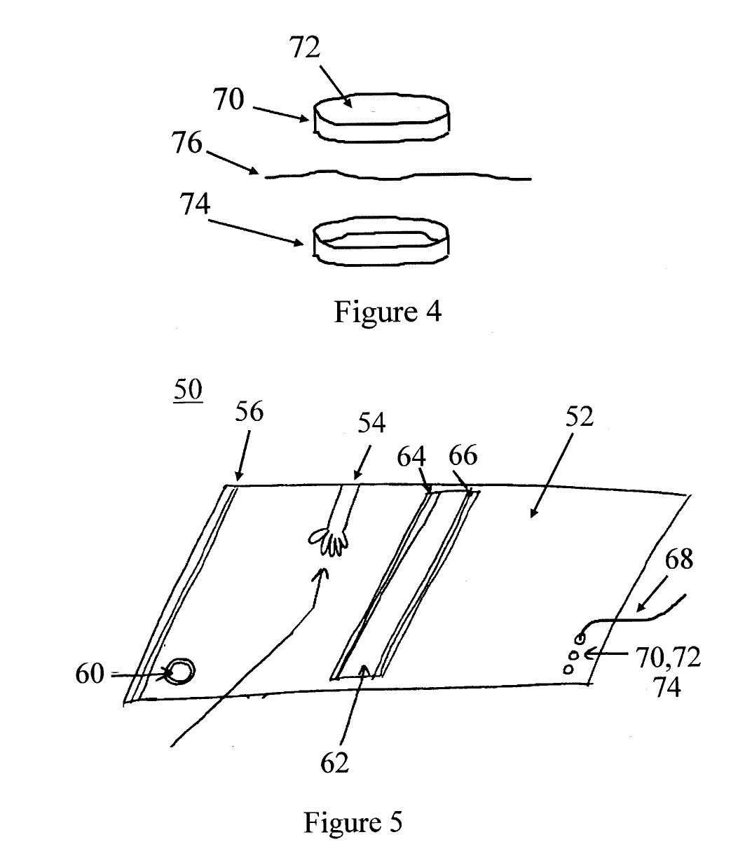

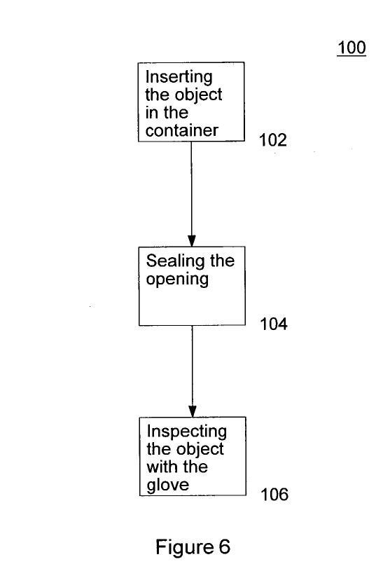

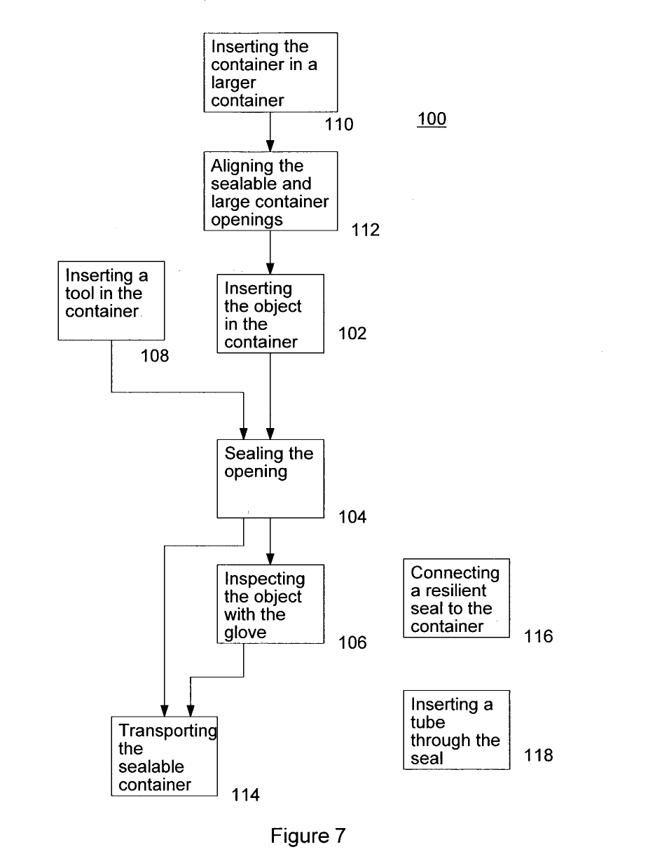

In operation, the bag 1 may be hung next to a mail slot by hanging means 7. Referring to FIG. 2, the bag 1 maybe placed in a mailbox 20 with the opening 2 of the bag folded back over the opening of the mailbox 21 such that any mail placed in the mailbox is placed in the bag 1. Referring to FIG. 3, the bag may also be used by placing it in a post office box 30 with the opening of the bag 2 substantially congruent with the opening of the box 31, again, such that any mail placed in the post office box is placed in the bag 1. Alternately, the bag can be used independently of any mail slot, mailbox or post office box. For example, a suspicious package can be placed in the bag 1, independently of any mail slot, mailbox or post office box.

Referring again to FIG. 1, when a letter or package in the bag is to be opened, means for opening the letter or package, such as a pair of scissors or a knife, may be inserted into the bag. The bag opening 2 is then sealed with closure means 3. The closed bag may then be removed from a mailbox or post office box, and, in any event, the bag may be taken to a convenient place for inspection of the contents. The person opening a letter or package then places his hands through the openings 3 and 4 into the gloves 5 and 6. The person then opens, and inspects the contents of, the letter or package in the bag, which remains contained in a substantially airtight system. If the contents do not appear to contain any chemical or biological agents, the bag may then be opened, the mail extracted, and the bag reused. If the contents do appear to contain any chemical or biological agents, the bag, still sealed, can be delivered to the appropriate governmental authority.

Thus, one purpose of the invention is a convenient and inexpensive system for recipients of letters or packages to inspect the contents thereof without risk of contaminating themselves or other persons. Another purpose of the invention is for governmental employees to inspect suspicious packages again without risk of contamination to themselves or other persons. It is also a purpose of the invention to provide a safe and simple means for inspecting letters or packages without overburdening public resources.

In an alternative description, the present invention is a material handling apparatus 50 for allowing an individual to safely handle and inspect any package or material. The apparatus 50 is a sealable, gas-impermeable container 52 having at least one glove 54 affixed to the container 52. Affixed is herein defined to mean the gloves 54 may be molded to the container 52, separately constructed and adhesively sealed in orifices in the container 52, or otherwise combined with the container 52 to maintain the gas-impermeable integrity of the container 52. The apparatus 50 allows the individual to handle materials within the container 52 using the gloves 54 while the container 52 is sealed and without allowing air to permeate the container 52. This basic design permits individuals to safely check their mail or other materials without fear of chemical or biological agents. Furthermore, if a chemical or biological agent is found, the material can be transported to the proper authorities in the container 52 without exposing anyone to the threat otherwise posed by the agent.

In one embodiment, the container 52 is substantially constructed of a flexible, translucent material, which allows an individual to maximize mobility with the gloves 54 and view the material in the container 52 from all possible angles. In another embodiment, the container 52 is transparent, 3 mil. plastic.

The container 52 has a sealable opening 56. The opening 56 can be adhesively sealable or mechanically sealable or sealable in some other manner that would be known to those skilled in the art.

In another embodiment, the present invention is a material handling apparatus 50 for allowing an individual to safely handle and inspect any package or material. The apparatus 50 includes a gas-impermeable container 52 having a sealable opening 56 at least one glove 54 molded into the container 52 whereby the individual can handle materials within the container 52 while the container 52 is sealed and without allowing air to permeate the container 52.

The apparatus 50 can further include an air filtration device 58 mounted along the container 52, whereby an individual within the container 52 would be able to breath through the container 52. Alternatively, the apparatus 50 can further include an orifice 60 fitted for an air intake supply and exhaust pump. These alternative embodiments of the present invention would allow a living person infected with a chemical or biological agent to be sealed within the container 52 without threat of suffocation.

In one embodiment, an IV or similar tube 68 for gas/liquid flow can be inserted into the container 52. Again, this embodiment is directed toward sustaining a living person within the container 52. This embodiment includes a first ring 70 having a resilient seal 72 and a second ring 74 mateable with the first ring 70. The seal 72 may be rubber, mechanical, or otherwise devised such that it will function with the remainder of the apparatus 50 to maintain the gas-impermeable nature of the container 52. Also, the second ring 74 may have a seal that works in conjunction with the seal 72 on the first ring 70. This embodiment further requires the container 52 to be comprised of a flexible material 76, such that the first and second ring are mateable with the flexible material there between. Mating rings 70,74 can patch an opening in the container 52. Also, an IV tube 68 could be inserted through the mated rings 70,74 such that the resilient seal 72 combines with the tube 68 to maintain the integrity of the gas-permeable container 52.

In one preferred embodiment, the sealable opening 56 is resealable, which would allow reuse of the apparatus 50.

In another embodiment, the apparatus 50 includes a pocket 62 within the container 52 having a resealable inside opening 64 and a resealable outside opening 66. The pocket 62 would allow an item to be passed into or out of the container 52 without permitting air flow into or out of the container. To accomplish passing an item out of the container 52, the item is inserted in the pocket 62 through the resealable inside opening 64 and, after sealing the resealable inside opening 64, the item can be retrieved through the resealable outside opening 66. Similarly, an item can be passed into the container 52, through the pocket 62.

The present invention can also be a method 100 for handling and inspecting a prospectively hazardous object. The first step in the method 100 is inserting 102 the object into a gas-impermeable container through a sealable opening. The next step in the method 100 is sealing 104 the opening. The final step in the inventive method 100 is inspecting 106 the object with at least one glove molded into the container. This method 100 keeps the object from being contaminated by anything outside the container and, conversely, protects everything outside the container from being contaminated by the object.

One embodiment of this novel method 100 involves inserting 108 at least one tool into the gas-impermeable container before the step of sealing 104 the opening. The tool can be scissors for opening a letter or package, a chemical detector, a chemical agent for counteracting a chemical agent in the object, or anything else that would assist an individual handling the object.

In another embodiment, this method 100 of claim 12 further includes two additional steps. The first additional step is inserting 110 the gas-impermeable container into a larger container, said larger container having a larger container opening. The second additional step is aligning 112 the sealable opening and the larger container opening. By completing these two steps, the step of inserting 102 the object into the gas-impermeable container through the sealable opening occurs when someone is inserting 110 the object in the larger container opening. This embodiment is primarily directed at lining the inside of a residential mailbox to protect residents and lining the inside of collection boxes to protect mail carriers, although other uses of this embodiment may be devised by those skilled in the art.

In another embodiment, the inventive method 100 can include the step of transporting 114 the container. Transporting 114 the container can be accomplished before or after inspecting 106 the object.

In another embodiment, directed primarily at running an IV or similar tube into the container, the inventive method 100 can include the steps of connecting 116 a resilient seal to the container and inserting 118 a tube into the container through the seal. The resilient seal will work in conjunction with the tube to maintain the gas-impermeable integrity of the container.

We claim:

1. A material handling apparatus for allowing an individual to safely handle and inspect any package or material, said apparatus consisting of:
a sealable, gas-impermeable container; and
at least one glove affixed into the container whereby the individual can handle materials within the container while the container is sealed and without allowing air to permeate the container.

2. The apparatus of claim 1 wherein the container is substantially constructed of a flexible, translucent material.

3. The apparatus of claim 1 wherein the container is adhesively sealable.

4. The apparatus of claim 1 wherein the container is mechanically sealable.

5. A material handling apparatus for allowing an individual to safely handle and inspect any package or material, said apparatus comprising:
a gas-impermeable container having a sealable opening; and
at least one glove molded into the container whereby the individual can handle materials within the container while the container is sealed and without allowing air to permeate the container.

6. The apparatus of claim 5 further comprising an air filtration device mounted along the container, whereby an individual within the container would be able to breath through the container.

7. The apparatus of claim 5 further comprising an orifice fitted for an air intake supply and exhaust pump.

8. The apparatus of claim 5 wherein the sealable opening is resealable.

9. The apparatus of claim 5 further comprising a pocket within the container having a resealable inside opening and a resealable outside opening whereby an item can be inserted in the pocket through the resealable inside opening and, after sealing the resealable inside opening, the item can be retrieved through the resealable outside opening, transferring the item out of the container without ever leaving the container unsealed.

10. The apparatus of claim 5 wherein the container is transparent, 3 mil. plastic.

11. The apparatus of claim 5 further comprising:
a first ring having a resilient seal whereby the seal may be rubber, mechanical, or otherwise devised such that it will function with the remainder of the apparatus to maintain the gas-impermeable nature of the container;
a second ring mateable with the first ring;
wherein the container is comprised of a flexible material;
wherein the first and second ring are mateable with the flexible material there between thereby allowing the rings to be used to patch an opening in the container or to be used to run a small hose into the container without damaging the integrity of the gas-permeable container.

12. A method for handling and inspecting a prospectively hazardous object, said method comprising the steps of:
inserting the object into a gas-impermeable container through a sealable opening;
sealing the opening; and
inspecting the object with at least one glove molded into the container thereby containing contamination concerns.

13. The method of claim 12 further comprising the step of inserting at least one tool into the gas-impermeable container before the step of sealing the opening.

14. The method of claim 12 further comprising the steps of:
inserting the gas-impermeable container in a larger container, said larger container having a larger container opening; and
aligning the sealable opening and the larger container opening whereby inserting the object in the larger container opening results in the step of inserting the object into the gas-impermeable container through the sealable opening.

15. The method of claim 12 further comprising the step of transporting the container.

16. The method of claim 12 further comprising the steps of:
connecting a resilient seal to the container; and
inserting a tube into the container through the seal.
